(19) United States
(12) Patent Application Publication
(10) Pub. No.: US 2002/0073433 A1
(43) Pub. Date: Jun. 13, 2002

(54) Cable modem, method for recording a downstream frequency in the same, and cable modem system

(76) Inventor: Tetsuro Furuta, Tokyo (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 09/797,824

(22) Filed: Mar. 5, 2001

(30) Foreign Application Priority Data
Dec. 7, 2000 (JP) P2000-373390

(51) Int. Cl. H04N 7/173

(52) U.S. Cl. 725/111; 725/126

(57) ABSTRACT

A cable modem which can be recorded with a downstream frequency, assigned by a cable modem terminate system in a cable modem system, before the cable modem is installed in the system, and can skip searching the whole range of downstream frequency for the assigned downstream frequency in order to reduce the time for searching.

### FIELD OF THE INVENTION

The present invention relates to a cable modem, which is used with a Cable Modem Terminate System (CMTS) in a cable modem system. The present invention, more particularly, relates to a cable modem capable of reducing time for searching for a downstream frequency, which is assigned to the cable modem by the CMTS, and to a method for recording the downstream frequency in the cable modem.

### BACKGROUND AND MATERIAL INFORMATION

A cable modem system, which performs data communication using a cable network constructed for a cable television (CATV), has recently become widespread. The CATV was originally mere a TV broadcasting system for providing a scriber with various services through a coaxial cable. In the cable modem system, data communication is performed using a frequency band other than frequency bands specified for TV, by a cable modem and a CMTS working in close cooperation with each other.

FIG. 2 is a block diagram showing a schematic constitution of a typical cable modem system. Each of cable modems 201, e.g., 201a and 201b is severally connected to a CMTS 203 via a CATV cable 202.

The CMTS 203 communicates with a provider's server 205 via the provider's network, which may be composed of a local area network (LAN) 204 according to 100BASE-T or asynchronous transfer mode (ATM). The server 205, which is disposed at a position generally called “head end”, provides each of cable modems 201 with necessary services, for example dynamic host configuration protocol (DHCP), trivial file transfer protocol (TFTP), and electric mail.

The CMTS 203 coverts digital data received from the server 205 to a radio frequency (RP) signal and transmits the RF signal to each cable modem 201. Moreover, the CMTS 203 converts an RF signal received from these cable modems 201 to digital data and transmits the digital data to the server 205. Generally, the communication direction from the CMTS 203 to each of cable modems 201 is called “downstream” and the opposite communication direction is called “upstream.”

DOCSIS (Data over cable service interface specifications) is widely known as a specification of a communication interface of the cable modems 201.

Each of cable modems 201 maybe placed at each scriber's house and be connected to each of personal computers (PCs) 206, e.g., 206a and 206b via a cable according to 10BASE-T or 100BASE-T, For example, the cable modem 201a is connected directly to the PC 206a, and the cable modem 201b is connected to the PC 206b via a hub 207. Each scriber transmits and receives data using each PCs 206 to obtain various services from the provider.

The cable modem 201a picks up a carrier, which is transmitted from the CMTS 203 on a downstream frequency assigned to the cable modem 201a itself, from the whole range of the downstream frequency band specified for the data communication. Then, the cable modem 201 extracts necessary data from the carrier and transmits the extracted data to the PC 206a.

Accordingly, when installed in the cable modem system, the cable modem 201a needs to search every channel for the carrier assigned to the cable modem 201a itself in order to perform the data transmission to the PC 206a. Generally, the downstream frequency band has a wide range from 88 MHz to 860 MHz and is composed of a plurality of channels each of which has a width of 6 MHz. So it takes between 2 and 6 minutes to perform the frequency search.

The cable modem 201a determines whether or not a carrier for data communication is received on a channel. When receiving the carrier, the cable modem 201a determines whether or not the carrier is assigned to the cable modem 201a itself.

When the carrier is assigned to the cable modem 201a, the cable modem 201a caches the downstream frequency of the channel in an internal memory. Consequently, during a subsequent data communication, the cable modem 210a can pick up the down stream frequency assigned to itself using the cached down stream frequency within several tens seconds.

There may be a case where the connection between cable modem 201a and the CATV cable 202 is disconnected for some reason, such as unplugged in error, during the operation of the cable modem 210a after caching the assigned downstream frequency. In this case, the CATV cable modem 201a needs to perform the frequency search for another downstream frequency. It takes between 2 and 6 minutes again until the cable modem become able to communicate with the CMTS 203 after the connection is restored.

As mentioned above, because a cable modem does not know the downstream frequency assigned to itself at the time of installation, the cable modem needs to perform the frequency search requiring considerable time.

On the other hand, the scriber or a person who installs the cable modem in the cable modem system generally knows the assigned downstream frequency at that time. Therefore, it is desired to develop a cable modem, which can be recorded with the assigned downstream frequency and can become able to communicate with a CMTS without the frequency search.

### SUMMARY OF THE INVENTION

Accordingly, the present invention is directed to a cable modem, a method for recording a downstream frequency in the cable modem, and the cable modem system that substantially obviates one or more of problems due to limitations and disadvantages of the prior art.

In accordance with the purpose of the present invention, as embodied and broadly described, the present invention is directed to a cable modem, which is connected with a CMTS via a CATV cable, for enabling a computer connected with the cable modem to perform data communication using the CATV cable. The cable modem comprises a memory, means for recording a downstream frequency assigned to the cable modem in the memory according to an instruction from the computer, a table storing a downstream frequency for each channel, means for selecting a channel corresponding to the downstream frequency recorded in the memory by referring to the table, a tuner for receiving a carrier wave of the selected channel, the carrier wave being transmitted from the CMTS, means for converting data carried by the carrier wave into a predetermined data form, means for determining whether the converted data is to be transmitted by the cable modem or not, and means for transmitting the converted data to the computer when the converted data is to be transmitted by the cable modem. The selecting means changes the current channel to another channel by referring to the table when the converted data is not to be transmitted by the cable modem.

Also in accordance with the present invention, there is provided a cable modem system in which a cable modem is connected with a CMTS via a CATV cable for enabling a computer connected with the cable modem to perform data communication using the CATV cable. The cable modem comprises a memory, means for recording a downstream frequency assigned to the cable modem in the memory according to an instruction from the computer, a table storing a downstream frequency for each channel, means for selecting a channel corresponding to the downstream frequency recorded in the memory by referring to the table, a tuner for receiving a carrier wave of the selected channel, the carrier wave being transmitted from the CMTS, means for converting data carried by the carrier wave into a predetermined data form, means for determining whether the converted data is to be transmitted by the cable modem or not, and means for transmitting the converted data to the computer. The selecting means changes the current channel to another channel by referring to the table when the converted data is not to be transmitted by the cable modem.

### BRIEF DESCRIPTION OF THE DRAWINGS

The accompanying drawings, which are incorporated in and constitute part of this specification, illustrate various embodiments and/or features of the invention and together with the description, serve to explain the principles of the invention. In the drawings;

FIG. 1 is a block diagram showing an example of a main configuration of a cable modem consistent with the present invention; and

FIG. 2 is a block diagrams showing a schematic constitution of a typical cable modem system.

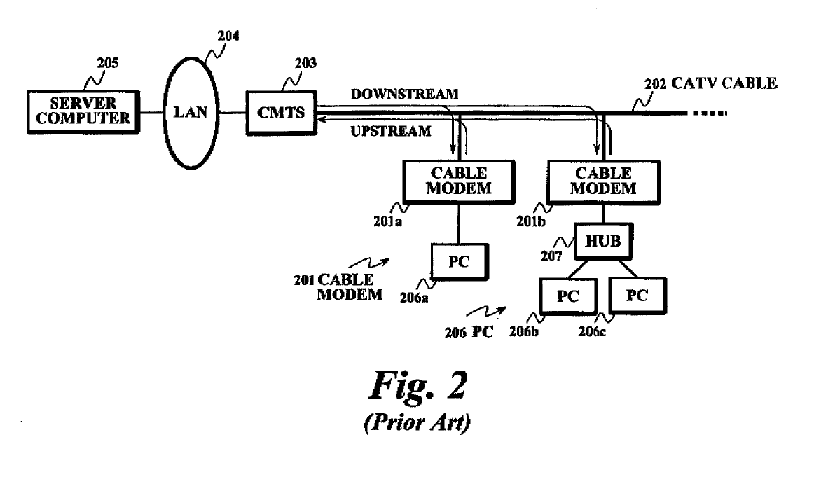

### DETAILED DESCRIPTION

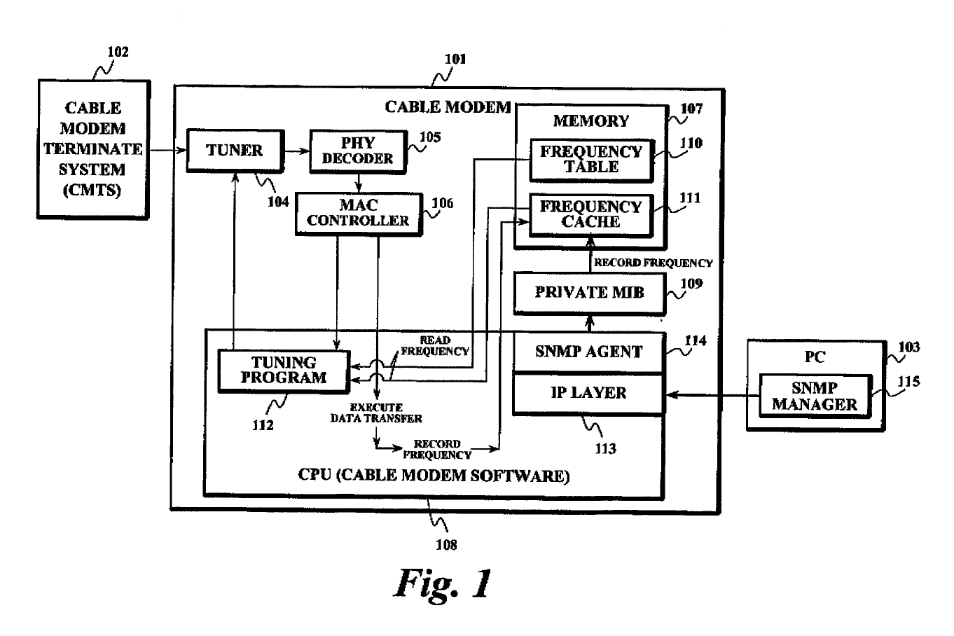

The embodiment of the present invention will be explained hereunder with reference to the accompanying drawings. FIG. 1 is a block diagram showing an example of a main configuration of a cable modem 101.

A cable modem 101, which is positioned between a CMTS 102 and a PC 103, has a tuner 104, a physical decoder (PHY decoder) 105, a MAC controller 106, a memory 107, a central processing unit (CPU) 108, and a private management information base (private MIB) 109, each of them as a function of performing a downstream frequency processing.

The tuner 104 switches a frequency band, channel by channel, to receive a downstream frequency transmitted from the CMTS 102 according to an instruction of a tuning program 112 (described later) and sequentially receives each downstream frequency corresponding to a channel.

The PHY decoder 105 converts analog data carried via the received downstream frequency to digital data of 64 QAM or 256 QAM and outputs the digital data to the MAC controller 106.

When receiving the digital data from the PHY decoder 105, the MAC controller 106 determines whether or not the received downstream frequency is a carrier which satisfies the requirements for the specification of the cable modem 101, such as whether DOCSIS carrier or not.

The memory 107 has a frequency table 110 in which the relation between the frequency band and the channel, and a frequency cache 111 for storing a downstream frequency assigned to the cable modem 101.

The CPU 108 manages the whole control of the cable modem 101 and internally has the tuning program 112, an IP layer 113, and a simple network management protocol (SNMP) agent 114. The tuning program 112 instructs the tuner 104 to switch to another channel by referring to the relation recorded in the frequency table 110 when the MAC controller 106 detects no carrier satisfying the requirements for the specification of the cable modem 101.

The MAC controller 106 performs the above detection process for each channel. When detecting the carrier satisfying the requirements, the MAC controller 106 temporally locks the current frequency band and downloads information on setting the cable modem 101, such as IP address, from the server.

When the above provisioning is completed, the cable modem 101 becomes able to communicate with the CMTS 102. And the CPU 108 records the locked frequency band in the frequency cache 111. Consequently, even if a power supply to the cable modem 101 is disconnected for some reason, the CPU 108 can recognize the assigned frequency band using the recorded frequency band in the frequency cache 111 when the power supply is recovered. The cable modem 101 is quickly restored to communicate with the CMTS 102 without performing the frequency search again.

The SNMP, which is defined in Request For Comments (RFC) 1157, is a protocol for monitoring a device connected to a network according to the user datagram protocol/Internet protocol (UDP/IP) via a network.

The PC 103 has an SNMP manager 115, which is a program for monitoring or managing the condition of a router or a hub and traffic condition of a network from the remote console using the SNMP.

On the other hand, the device, which is managed by the SNMP, has a program called MIB. The MIB generally defines the items to be managed by the SNMP and holds a variable indicating the condition of the device itself.

The NIB is to be basically installed in each device and is specified by RFC. In this embodiment, the cable modem 101 has a unique MIB, namely, private MIB 109. The private MIB 109 is used as a new code for recording the downstream frequency in the frequency cache 111. The basic specification of the MIB is specified by RFC 1213. However, the specification is still being expanded even now.

The SNMP agent 114, which is a program according to the SNMP, manages the MIB including the private MIB 109 in the cable modem 101. Also the SNMP agent 114 transmits the MIB to the SNMP manager 115 and operates the cable modem 101 according to a request from the SNMP manager 115. The UDP is used for communicating with the SNMP manager 115 via the IP layer 113.

Next, the procedure for recording the downstream frequency with the frequency cache 111 will be explained.

The cable modem 101 is given a default IP address, such as 192.168.100.1. So the customer premises equipment (CPE), such as the PC 103, can access the cable modem 101 using the default IP address even before the cable modem 101 becomes able to communicate with the CMTS 102.

Therefore, a scriber or an installer of the cable modem 101 instructs the SNMP agent 114, by the SNMP manager 115 on the PC 103 via the IP layer 113, to make the private MIB 109 to record the downstream frequency assigned to the cable modem 101 in the frequency cache 111.

Consequently, the tuning program 112 can instruct the tuner 104 to select the frequency band recorded in the frequency cache 11 without executing the frequency search when the cable modem 101 is connected to the CMTS 102.

Even in a case where there are a plurality of CMTSs 102 or a plurality of downstream frequencies, the private MIB 109 records these downstream frequencies in the frequency cache 111 in the same way. The tuning program 112 instructs the tuner 104 to search the carrier for the recorded frequencies. The cable modem 101 can catch the downstream frequencies immediately.

Some methods for quickly searching the assigned downstream frequencies after disconnection of the cable will be explained hereunder. Even when the downstream frequency carrier is lost, the cable modem 101 can efficiently search for the assigned downstream frequency by the following ways.

(1) Searching only the channels recorded in the frequency cache 111 for the downstream frequency;

(2) Searching a predetermined number of channels for the downstream frequency, searching a predetermined part of the frequency cache 111 for the downstream frequency, repeating these search by turns.

(3) Searching only frequency bands recorded in the frequency cache 111 in order to reduce the width of frequency band to be searched, namely, skipping the other bands.

In the above explanation, software applying to the SNMP is used as an interface for instructing the private MIB 109 to perform cache recording. However, another software using such as the HTTP may be used.

What is claimed is:

1. A cable modem, which is connected with a cable modem terminate system (CMTS) via a CATV cable, for enabling a computer connected with the cable modem to perform data communication using the CATV cable, comprising:
a memory;
means for recording a downstream frequency assigned to the cable modem in the memory according to an instruction from the computer;
a table storing a downstream frequency for each channel;
In means for selecting a channel corresponding to the downstream frequency recorded in the memory by referring to the table;
a tuner for receiving a carrier wave of the selected channel, the carrier wave being transmitted from the CMTS;
means for converting data carried by the carrier wave into a predetermined data form;
means for determining whether the converted data is to be transmitted by the cable modem or not; and
means for transmitting the converted data to the computer when the converted data is to be transmitted by the cable modem; wherein
the selecting means changes the current channel to another channel by referring to the table when the converted data is not to be transmitted by the cable modem.

2. The cable modem of claim 1, wherein;
the memory is a cache memory.

3. The cable modem of claim 1, wherein the recording means comprises:
a MIB which records the assigned downstream in the an interface, according to SNMP, which receives the instruction from the computer and provides it to the MIB.

4. The cable modem of claim 1, wherein the recording means comprises:
a MIB which records the assigned downstream in the memory; and
an interface, according to HTTP, which receives the instruction from the computer and provides it to the MIB.

5. A method for recording a downstream frequency in a cable modem, which is connected with a CMTS via a CATV cable, for enabling a computer connected with the cable modem to perform data communication using the CATV cable, comprising;
issuing an instruction to record a downstream frequency assigned to the cable modem from the computer;
recording the assigned downstream frequency in the memory according to the instruction;
storing a downstream frequency for each channel in a table;
selecting a channel corresponding to the downstream frequency recorded in the memory by referring to the table;
receiving a carrier wave of the selected channel, the carrier wave being transmitted from the CMTS;
converting data carried by the carrier wave into a predetermined data form;
determining whether the converted data is to be transmitted by the cable modem or not; and
transmitting the converted data to the computer when the converted data is to be transmitted by the cable modem;
changing the current channel to another channel by referring to the table when the converted data is not to be transmitted by the cable modem.

6. A cable modem system in which a cable modem is connected with a CMTS via a CATV cable for enabling a computer connected with the cable modem to perform data communication using the CATV cable, wherein the cable modem comprising:
a memory;
means for recording a downstream frequency assigned to the cable modem in the memory according to an instruction from the computer;
a table storing a downstream frequency for each channel;
means for selecting a channel corresponding to the downstream frequency recorded in the memory by referring to the table;
a tuner for receiving a carrier wave of the selected channel, the carrier wave being transmitted from the CMTS;
means for converting data carried by the carrier wave into a predetermined data form;
means for determining whether the converted data is to be transmitted by the cable modem or not; and
means for transmitting the converted data to the computer; wherein
the selecting means changes the current channel to another channel by referring to the table when the converted data is not to be transmitted by the cable modem.

7. The cable modem system of claim 6, wherein:
the memory is a cache memory.

8. The cable modem system of claim 6, wherein the recording means comprises:
a MIB which records the assigned downstream in the memory; and
an interface, according to SNMP, which receives the instruction from the computer and provides it to the MIB.

9. The cable modem system of claim 6, wherein the recording means comprises:
a MIB which records the assigned downstream in the memory; and
an interface, according to HTTP, which receives the instruction from the computer and provides it to the MIB.
